(19) United States
(12) Patent Application Publication
(10) Pub. No.: US 2026/0138929 A1
(43) Pub. Date: May 21, 2026

(54) SYSTEMS AND METHODS OF FABRICATING A CARBON CARBON COMPOSITE MATERIAL

(71) Applicant: Blue Origin Manufacturing, LLC, Huntsville, AL (US)

(72) Inventors: Sungbo Shim, Irvine, CA (US); James Steibel, Mason, OH (US)

(21) Appl. No.: 19/347,086

(22) Filed: Oct. 1, 2025

Related U.S. Application Data
(60) Provisional application No. 63/703,534, filed on Oct. 4, 2024.

(51) Int. Cl. C04B 35/83; C04B 35/626; C04B 35/628; C04B 35/64

(52) U.S. Cl. CPC C04B 35/83; C04B 35/62655; C04B 35/62873; C04B 35/62886; C04B 35/62892; C04B 35/64; C04B 2235/422; C04B 2235/48; C04B 2235/5248; C04B 2235/5256; C04B 2235/5436; C04B 2235/616

(57) ABSTRACT

A method of fabricating a carbon carbon (C/C) composite material is provided. In one aspect, the method includes providing a 3D or 2.5D woven carbon fiber preform and providing a slurry. The slurry includes a solvent and 50 to 70 volume percent carbon particles. The method also includes infiltrating the slurry into the preform and drying the solvent. The method further includes infiltrating a carbonaceous resin into the preform and heating the preform to fabricate the C/C composite material.

### CROSS-REFERENCE TO RELATED APPLICATIONS

This application claims priority to U.S. Provisional Patent Application No. 63/703,534 filed on Oct. 4, 2024, and entitled “SYSTEMS AND METHODS OF FABRICATING A CARBON CARBON COMPOSITE MATERIAL.” Each application referenced in this paragraph is hereby incorporated in its entirety by reference herein.

### BACKGROUND

### Field

The technology relates generally to carbon materials. In particular, the present disclosure relates to methods of forming a carbon composite material, for example, a carbon carbon (C/C) composite material.

### Description of the Related Art

Carbon carbon (C/C) composite materials are high performance materials that can be used in high temperature environments, such as in components for aircraft, spacecraft, rockets, missiles, and other vehicles. C/C composites can be fabricated by laminating 2D pre-impregnated fabrics (“prepregs”) followed by consolidation, carbonization, and multiple resin infiltrations and heat treatments. The entire process can be labor intensive and time consuming. For example, a supplier turn-around time can be over one year. C/C composites can also have low interlaminar tension or shear strength due to lack of through-thickness direction reinforcement.

### SUMMARY

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing methods of fabricating carbon materials such as carbon composites, for example, carbon carbon (C/C) composite materials.

In various implementations, a method of fabricating a carbon carbon (C/C) composite material is provided. The method can include providing a 3D or 2.5D woven carbon fiber preform, providing a slurry comprising a solvent and 50 to 70 volume percent carbon particles, and infiltrating the slurry into the preform. The method can include drying the solvent, infiltrating a carbonaceous resin into the preform, and heating the preform to fabricate the C/C composite material.

In some embodiments, providing a 3D or 2.5D woven carbon fiber preform can include providing a preform that has been woven into a net shape.

In some embodiments, the slurry can include 50 to 65 volume percent carbon particles.

In some instances, the slurry can include 60 to 65 volume percent carbon particles.

In some embodiments, the carbon particles can have an average particle size less than or equal to 20 microns.

In some instances, the carbon particles can have an average particle size less than or equal to 5 microns.

In some instances, the carbon particles can have an average particle size less than or equal to 1 micron.

In some embodiments, the carbon particles in the slurry can be configured to fill at least 50 percent of the volume of the pores of the preform.

In some embodiments, after infiltrating the slurry into the preform and drying the solvent, the preform can include less than 20 volume percent porosity.

In some embodiments, after infiltrating the slurry into the preform and drying the solvent, a maximum pore size in the preform can be 100 microns,

In some instances, after infiltrating the slurry into the preform and drying the solvent, an average pore size in the preform can be in the range of less than or equal to 1 micron.

In some embodiments, the carbonaceous resin can include phenolic resin, furfuryl alcohol resin, or cyanate ester.

In some embodiments, heating the preform can include pyrolyzing the carbonaceous resin.

In some embodiments, heating the preform can include graphitization and crystallization of the carbonaceous resin.

In some embodiments, infiltrating a carbonaceous resin into the preform and heating the preform can be repeated.

In some instances, infiltrating the carbonaceous resin into the preform and heating the preform can be repeated only once.

In some embodiments, the C/C composite material can include a continuous matrix of carbon,

In some embodiments, the C/C composite material can have no more than 5 volume percent porosity.

In some embodiments, the C/C composite material can have a maximum pore size of 5 microns.

In some embodiments, the C/C composite material can have an average pore size in the range of less than or equal to 0.5 micron.

### BRIEF DESCRIPTION OF THE DRAWINGS

In the following detailed description, reference is made to the accompanying drawing, which form a part hereof. Understanding that this drawing depicts only one embodiment in accordance with the present disclosure and is not to be considered limiting of its scope, the present disclosure will be described with additional specificity and detail through use of the accompanying drawing. The illustrative embodiments described in the detailed description, drawing, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figure, can be arranged, substituted, combined, and designed in a wide variety of different configurations, all of which are explicitly contemplated and make part of this disclosure.

FIG. 1 is a flow chart representing an example method of fabricating a carbon carbon composite material according to an embodiment of the present disclosure.

### DETAILED DESCRIPTION

Carbon carbon (C/C) composite materials, for example carbon fibers in a carbon matrix material, can provide a lightweight material with excellent mechanical properties at high temperatures. Such materials can be particularly advantageous in applications subjected to a rapid increase in temperature. Some applications include but are not limited to components for aircraft, spacecraft, rockets, missiles, and other vehicles. For example, C/C composites can be used for components in heavy-lift orbital launch vehicles, lunar landers, hypersonic missiles, hypersonic vehicles, thermal protection systems for space vehicles, rocket motor nozzles throats, rocket exit cones, rocket nose cones, aircraft brakes, etc. Embodiments of the present disclosure generally relate to the fabrication of carbon composites, for example, C/C composite materials for components described above and for any other structure including C/C composite materials. In various embodiments, methods of fabricating a C/C composite material are provided which can advantageously be simple and cost-effective, for example, with few processing steps, while providing C/C composite materials with improved interlaminar properties.

Various example embodiments of methods according to the present disclosure will now be described. In various implementations, a woven carbon fiber preform can be used to provide the carbon fibers of the C/C composite material, and a carbonaceous resin can be pyrolyzed to provide the carbon matrix of the C/C composite material. Compared to laminating multiple 2D woven carbon fiber preforms (e.g., preforms with fibers disposed in one plane), 2.5D woven carbon fiber preforms (e.g., preforms with fibers disposed in two perpendicular planes) and 3D woven carbon fiber preforms (e.g., preforms with fibers disposed in three perpendicular planes) can be provided to increase interlaminar strength. However, a 2.5D or 3D woven carbon fiber preform may have larger pores (e.g., pockets, voids, openings, etc.) between preform fibers and/or form larger pores after resin infiltration. As a result, using a 2.5D or 3D woven carbon fiber preform can yield resin-rich pockets after infiltrating the preform with carbonaceous resin. In various implementations, before infiltrating carbonaceous resin into the preform and pyrolyzing to form a C/C composite material, a high-solid loading slurry (e.g., a slurry having a solvent and at least 50 volume percent particles such as 50, 55, 60, 65, or 70 volume percent particles) can be infiltrated into the 2.5D or 3D woven carbon fiber preform. When heated to dry the solvent, the particles from the slurry can help reduce the formation of pores and/or can remain to help fill the pores of the woven carbon fiber preform. Using particles from a slurry to reduce the porosity in the 2.5D or 3D woven carbon fiber preform can advantageously result in using less resin and infiltration cycles. In some examples, the fabricated C/C composite material can be used as a component for launch vehicles, lunar landers, hypersonic missiles, hypersonic vehicles, thermal protection systems for space vehicles, rocket motor nozzles throats, rocket exit cones, rocket nose cones, aircraft brakes, and the like.

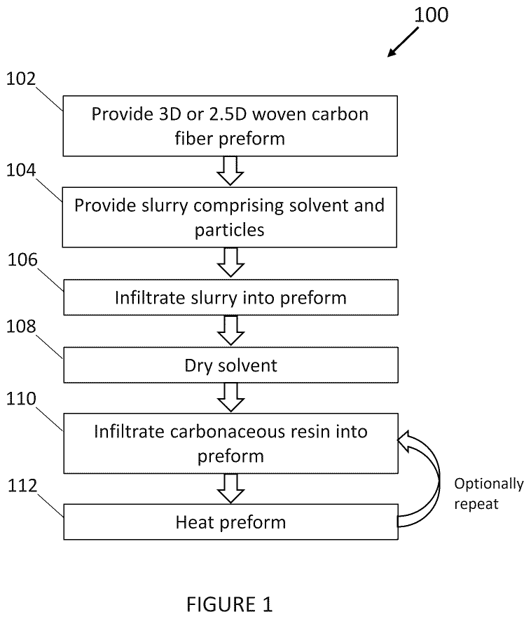

FIG. 1 is a flow chart representing an example method 100 of fabricating a C/C composite material according to an embodiment of the present disclosure. In various implementations, the fabricated C/C composite material can undergo a reduced number of processing steps relative to standard techniques (e.g., a reduced number of resin infiltration cycles) and provide interlaminar strength. For example, the fabricated C/C composite material according to embodiments of the present disclosure can undergo one, two, or three infiltration steps. In comparison, typical fabricated C/C composite material may undergo as many as five, six, seven, eight, nine, ten, or more infiltration cycles. The method 100 can begin at block 102, where a 3D or 2.5D woven carbon fiber preform is provided. The provided 3D or 2.5D woven carbon fiber preform can be any 3D or 2.5D woven carbon fiber preform known in the art or yet to be developed. A 2D woven carbon fiber preform can include preforms with carbon fibers woven in at least two directions within a single plane. A 2.5D woven carbon fiber preform can include preforms with carbon fibers woven in two perpendicular planes. For example, a 2.5D woven carbon fiber preform can include a 2D woven carbon fiber preform with additional carbon fibers woven along a second plane perpendicular to the plane of the 2D preform. A 3D woven carbon fiber preform can include preforms with carbon fibers woven in three perpendicular planes. For example, a 3D woven carbon fiber preform can include a 2.5D woven carbon fiber preform with additional carbon fibers disposed along a third plane perpendicular to the two planes of the 2.5D preform. In various instances, the difference between 2.5D and 3D can be the number of ply layers the fibers intersect in a third direction. For example, in a full 3D orthogonal weave, the z-direction fibers can intersect many if not all ply layers, whereas in an angle interlock 2.5D weave, the z-direction fibers may only intersect adjacent ply layers.

Compared to laminating multiple 2D woven carbon fiber preforms together to form composite structures, using 3D and 2.5D woven carbon fiber architectures having fibers woven along one or more additional planes can result in structures with higher interlaminar strength. Other advantages of using 3D and 2.5D woven preforms include being able to weave the preform into a net shape. For example, the provided preform can be woven into a desired shape. In addition, the carbon fibers in the 3D and 2.5D woven carbon fiber preform can form the fibers in the C/C composite material. In various instances, the carbon fibers can have low to intermediate elastic modulus, for example, to be suitable for weaving into 3D and 2.5D preforms. In some instances, the carbon fibers in the preform can have a high elastic modulus. In some examples, the carbon fibers in the preform can be 95 to 100% pure carbon.

In contrast to the above-described advantages associated with 3D and 2.5D woven carbon fiber architectures, 3D and 2.5D woven preforms may be associated with and/or form relatively high porosity, which can be disadvantageous. For example, compared to laminating multiple 2D woven fiber preforms together, 3D and 2.5D woven fiber preforms can have more porosity between preform fibers and/or form larger pores after resin infiltration, resulting in resin-rich pockets. Methods of fabricating C/C composite materials involving resin-rich pockets may be associated with reduced interlaminar strength in the formed C/C composite materials if not well-densified, increased manufacturing costs (due to the increase in resin to fill the pockets), and increased processing time (due to the increase in infiltration cycles to fill and densify the pockets). In some instances, the provided 3D or 2.5D woven carbon fiber preform may have a porosity in the range from 60 to 75 volume percent porosity. The average pore size (for example, an average diameter or an average largest dimension) or a median pore size (for example, a median diameter or a median largest dimension) of the pores in the preform can be in the range of 250 to 2000 microns. Various methods described herein can advantageously reduce the amount of porosity of the preform prior to adding and pyrolyzing carbonaceous resin to form the C/C composite material and/or reduce the amount of porosity formed after resin infiltration.

For example, at block 104, a slurry is provided. As an example, in some embodiments, a slurry (or other semiliquid mixture or mixture of insoluble solids suspended in a liquid) can include a solvent and particles. In some examples, the particles in the slurry can include carbon particles. In some instances, the particles in the slurry can include ceramic particles such as silicon carbide (SiC), zirconium diboride (ZrB₂), zirconium carbide (ZrC), and/or hafnium carbide (HfC) and some carbon particles. After the particles are infiltrated into the preform, as described below with reference to block 106, and after drying the solvent, as described below with reference to block 108, the particles from the slurry can remain in the carbon fiber preform to reduce the amount of porosity between preform fibers and/or reduce the formation of porosity after resin infiltration. In various embodiments, the solvent can include water. The slurry can also include a binder, a dispersant such as polyethylenimine, and/or a gelation agent such as N,N-dimethylacrylamide (DMMA). Other solvents and additives can also be used.

The slurry can be a high-solid loading slurry. In some embodiments, the slurry can include carbon particles in the range of at least 50 volume percent carbon particles such as 50, 55, 60, 65, 70 volume percent carbon particles, or any other volume percent within this range. In some embodiments, the slurry can include a volume percent of carbon particles that is in any range within this range, for example, any range formed by any of the foregoing values, such as 50 to 70 volume percent, 50 to 65 volume percent, 50 to 60 volume percent, 55 to 70 volume percent, 55 to 65 volume percent, 60 to 70 volume percent, 60 to 65 volume percent, etc.

The carbon particles can include any type of carbon, such as diamond, graphite, and/or carbon black. In various implementations, the carbon particles can have an average particle size (for example, an average diameter or an average largest dimension) or a median particle size (for example, a median diameter or a median largest dimension) in the range less than or equal to 20 microns such as 0.05, 0.1, 0.2, 0.3, 0.4, 0.5, 0.6, 0.7, 0.8, 0.9, 1, 2, 3, 4, 5, 7, 10, 12, 15, 20 microns, or any other size within this range. In some embodiments, the average particle size or median particle size can be in any range within this range, for example, any range formed by any of the foregoing values, such as less than or equal to 15 microns, less than or equal to 10 microns, less than or equal to 5 microns, less than or equal to 1 micron, from 0.05 to 20 microns, 0.05 to 15 microns, 0.05 to 10 microns, 0.05 to 5 microns, 0.05 to 1 micron, 0.1 to 20 microns, 0.1 to 15 microns, 0.1 to 10 microns, 0.1 to 5 microns, 0.1 to 1 micron, 0.2 to 20 microns, 0.2 to 15 microns, 0.2 to 10 microns, 0.5 to 20 microns, 0.5 to 15 microns, 0.5 to 10 microns, etc. In various embodiments, smaller particle sizes for the carbon particles may be preferred to penetrate the woven carbon fiber preform. For example, in some instances, carbon particles less than or equal to 1 micron can be used to penetrate a woven carbon fiber preform having pores 3-4 orders of magnitude larger than the carbon particles. In some instances, a bimodal distribution or multiple particle sizes of the carbon particles can be used to enhance packing density. By filling at least part of the pores of the carbon fiber preform, less carbonaceous resin and infiltration cycles can be used. In some instances, the carbon particles in the slurry can be configured to fill at least 50, 60, 70, 80, etc. percent of the volume of the pores of the preform.

Other examples of slurries are possible. For example, in some instances, the particles in the slurry can include ceramic particles such as silicon carbide (SiC), zirconium diboride (ZrB₂), zirconium carbide (ZrC), and/or hafnium carbide (HfC) and some carbon particles.

In various implementations, using a slurry with 50 to 70 volume percent particles can provide a relatively high amount of particles to fill pores of the fiber preform, while at the same time maintaining the amount of particles relatively low enough to provide a slurry having a viscosity suitable for infiltration. Accordingly, embodiments of the present disclosure using a slurry with 50 to 70 volume percent particles can advantageously fill pores of the fiber preform while also maintaining a slurry having an optimal viscosity. In some instances, the viscosity of the slurry can be in the range from 800 to 2000 cP (or mPa·s) such as 800, 900, 1000, 1100, 1200, 1300, 1400, 1500, 1600, 1700, 1800, 1900, 2000 cP (or mPa·s) or any other viscosity within this range. In some embodiments, the viscosity can be within any range within this range, for example, any range formed by any of the foregoing values, such as 900 to 2000 cP, 900 to 1900 cP, 900 to 1800 cP, 1000 to 2000 cP, 1000 to 1900 cP, 1000 to 1800 cP, etc.

Moving to block 106, the provided slurry can be infiltrated into the carbon fiber preform. The slurry can be infiltrated using any method known in the art or yet to be developed. For example, the slurry can be applied to the carbon fiber preform by slurry casting, pressure casting, slurry impregnation, etc. As shown in block 108, after infiltration, the solvent can be dried. The solvent can be dried using any method known in the art or yet to be developed. The drying conditions (e.g., temperatures, times, environments, etc.) can depend on the type of solvent used and the respective vapor pressure. In some examples, the slurry can be heated to a temperature in the range of 90° C. to 120° C. After drying the solvent, the particles from the slurry can remain to fill the pores (e.g., at least part of the pores) of the carbon fiber preform such that the preform can have a porosity that is in the range of less than or equal to 20 volume percent such as 20, 18, 15, 12, 10, 8, 5, etc. volume percent, or any other volume percent within this range. In some embodiments, the porosity of the preform after drying the solvent can be in any range within this range, for example, any range formed by any of the foregoing values, such as 8 to 20 volume percent, 8 to 18 volume percent, 8 to 15 volume percent, 10 to 20 volume percent, 10 to 18 volume percent, etc.

In various implementations, after drying the solvent in block 108, the maximum pore size (for example, a maximum diameter or a maximum largest dimension) of pores in the preform can be in the range of 10 to 100 microns, such as 10, 20, 30, 40, 50, 60, 70, 80, 90, 100, etc. microns. In some embodiments, the maximum pore size of pores in the preform after drying can be in any range within this range, for example, any range formed by any of the foregoing values, such as 20 to 100 microns, 30 to 100 microns, 40 to 100 microns, 50 to 100 microns, 10 to 90 microns, 10 to 80 microns, 10 to 70 microns, 10 to 60 microns, 10 to 50 microns, etc. In some instances, after drying the solvent in block 108, the average pore size (for example, an average diameter or an average largest dimension) or a median pore size (for example, a median diameter or a median largest dimension) of the pores in the preform can be in the range of less than or equal to 1 micron, for example, less than 1 micron, less than 0.9 micron, less than 0.8 micron, less than 0.7 micron, less than 0.6 micron, etc.

Moving to block 110, a carbonaceous resin can be infiltrated into the preform. The carbonaceous resin can be any carbonaceous resin known in the art or yet to be developed. For example, the carbonaceous resin can include a high char yielding carbonaceous resin such as phenolic resin, furfuryl alcohol resin, or cyanate ester. In various methods, because the amount of porosity in the preform has been reduced, less resin can be used. The resin can be infiltrated into the preform using any method known in the art or yet to be developed. For example, the resin can be infiltrated into the preform by resin transfer molding, resin infusion, vacuum infiltration, etc. After infiltration of the resin, the infiltrated preform can undergo a heat treatment as shown in block 112. In some instances, the infiltrated preform can be heated to a temperature in the range of 900° C. to 1100° C. In some instances, the heat treatment can be in a gas purged environment such as an argon or nitrogen gas purged environment. The heat treatment can form or fabricate a C/C composite material. For example, the heat treatment can pyrolyze the carbonaceous resin to form a carbon matrix. The carbon matrix along with the carbon fibers from the carbon fiber preform can form a C/C composite material. In various embodiments, the carbon matrix formed by this process can include a continuous matrix of carbon (e.g., a matrix where the carbon from the carbonaceous resin and the carbon particles are intermixed and/or fused together). For example, in some instances, when the resin has been carbonized at 1100° C. or below, the carbon particles can become embedded in the carbon char to create part of the matrix. In some instances the carbon char portion of the matrix may be amorphous and the carbon particles may be lightly bonded.

As shown in FIG. 1, infiltrating carbonaceous resin into the preform and heating the preform can be optionally repeated to attain the desired properties. For example, in various instances, infiltrating carbonaceous resin into the preform and heating the preform can be repeated to reach a desired density. In some instances, due to the particles from the slurry reducing the porosity of the carbon fiber preform, infiltrating the carbonaceous resin into the preform and heating the preform may be repeated only a few times (e.g., only once, twice, or three times). In some implementations of the method, heating the preform may include graphitization and/or crystallization of the carbonaceous resin. Graphitization and/or crystallization can occur simultaneous with or sequential to pyrolyzation. Graphitization can involve heat treatment at high processing temperatures, such as 1600° C. to 2000° C. In some embodiments, the carbon matrix can crystallize and fuse with the carbon particles to improve the matrix strength. In some instances, the added crystallinity can lead to gains in thermal conductivity, which can be useful in applications with high thermal gradients.

After heat treatment, in various implementations, the fabricated C/C composite material may have a porosity in the range of no more than 5 volume percent porosity, such as 5, 4, 3, 2, 1, 0.5, 0, etc. volume percent porosity, or any other volume percent within this range. In some embodiments, the porosity can be in any range within this range, for example, any range formed by any of the foregoing values, such as 0.05 to 5 volume percent, 0.05 to 4 volume percent, 0.05 to 3 volume percent, 1 to 5 volume percent, 1 to 4 volume percent, 1 to 3 volume percent, 2 to 5 volume percent, etc. Some embodiments may include higher amounts of porosity if desired. In various implementations, the maximum pore size (for example, a maximum diameter or a maximum largest dimension) of the C/C composite material can be in the range of 1 to 5 microns, such as 1, 2, 3, 4, or 5 microns. In some embodiments, the maximum pore size of the C/C composite material can be in any range within this range, for example, any range formed by any of the foregoing values. In some instances, the average pore size (for example, an average diameter or an average largest dimension) or a median pore size (for example, a median diameter or a median largest dimension) of the C/C composites material can be in the range of less than or equal to 0.5 micron, for example, less than 0.5 micron, less than 0.4 micron, less than 0.3 micron, etc.

As described herein, various embodiments of the present disclosure can provide methods to fabricate a carbon material, for example, a carbon composite material such as a C/C composite material. In various embodiments, methods of fabrication described herein can utilize 3D or 2.5D woven carbon fiber architectures. The methods can be simple and cost effective, for example, with few processing steps (e.g., few resin infiltration cycles). In addition, the C/C composite material can have improved interlaminar strength.

In some examples of the present disclosure, the methods can include additional blocks during which further processing is performed. In addition, it will be understood that the methods need not be performed in the order described and/or some steps may be omitted.

While the above detailed description has shown, described, and pointed out novel features of the present disclosure as applied to various embodiments, it will be understood that various omissions, substitutions, and changes in the form and details of the process illustrated may be made by those skilled in the art without departing from the spirit of the present disclosure. As will be recognized, the present disclosure may be embodied within a form that does not provide all of the features and benefits set forth herein, as some features may be used or practiced separately from others. All changes which come within the meaning and range of equivalency of the claims are to be embraced within their scope.

The detailed description is directed to certain specific embodiments of the present disclosure. Reference in this specification to “one embodiment,” “an embodiment,” or “in some embodiments” means that a particular feature, structure, or characteristic described in connection with the embodiment is included in at least one embodiment of the present disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others.

The terminology used in the description presented herein is not intended to be interpreted in any limited or restrictive manner, simply because it is being utilized in conjunction with a detailed description of certain specific embodiments of the development. Furthermore, embodiments of the present disclosure may include several novel features, no single one of which is solely responsible for its desirable attributes or which is essential to practicing the present disclosure.

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity. In addition, it will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

Furthermore, in those instances where a convention analogous to “at least one of A, B, and C, etc.” is used, in general such a construction is intended in the sense one having skill in the art would understand the convention (e.g., “a method having at least one of A, B, and C” would include but not be limited to methods that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawing, should be understood to contemplate the possibilities of including one of the terms, either of the terms, or both terms. For example, the phrase “A or B” will be understood to include the possibilities of “A” or “B” or “A and B.”

All numbers expressing quantities, dimensions, and so forth used in the specification and claims are to be understood as being modified in all instances by the term “about.” Accordingly, unless indicated to the contrary, the numerical parameters set forth in the specification are approximations that may vary depending upon the desired properties sought to be obtained by embodiments of the present disclosure. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various embodiments, of ±1%, ±5%, ±10%, or ±20%.

The above description discloses several methods and materials of the present disclosure. The present disclosure is susceptible to modifications in the methods and materials, as well as alterations in the fabrication methods and equipment. Such modifications will become apparent to those skilled in the art from a consideration of this disclosure. Consequently, it is not intended that the present disclosure be limited to the specific embodiments disclosed herein, but that it covers all modifications and alternatives coming within the true scope and spirit of the present disclosure.

What is claimed is:

1. A method of fabricating a carbon carbon (C/C) composite material, the method comprising:
providing a 3D or 2.5D woven carbon fiber preform;
providing a slurry comprising a solvent and 50 to 70 volume percent carbon particles;
infiltrating the slurry into the preform;
drying the solvent;
infiltrating a carbonaceous resin into the preform; and
heating the preform to fabricate the C/C composite material.

2. The method of claim 1, wherein providing a 3D or 2.5D woven carbon fiber preform comprises providing a preform that has been woven into a net shape.

3. The method of claim 1, wherein the slurry comprises 50 to 65 volume percent carbon particles.

4. The method of claim 3, wherein the slurry comprises 60 to 65 volume percent carbon particles.

5. The method of claim 1, wherein the carbon particles have an average particle size less than or equal to 20 microns.

6. The method of claim 5, wherein the carbon particles have an average particle size less than or equal to 5 microns.

7. The method of claim 6, wherein the carbon particles have an average particle size less than or equal to 1 micron.

8. The method of claim 1, wherein the carbon particles in the slurry are configured to fill at least 50 percent of the volume of the pores of the preform.

9. The method of claim 1, wherein, after infiltrating the slurry into the preform and drying the solvent, the preform comprises less than 20 volume percent porosity.

10. The method of claim 1, wherein, after infiltrating the slurry into the preform and drying the solvent, a maximum pore size in the preform is 100 microns.

11. The method of claim 1, wherein, after infiltrating the slurry into the preform and drying the solvent, an average pore size in the preform is in the range of less than or equal to 1 micron.

12. The method of claim 1, wherein the carbonaceous resin comprises phenolic resin, furfuryl alcohol resin, or cyanate ester.

13. The method of claim 1, wherein heating the preform comprises pyrolyzing the carbonaceous resin.

14. The method of claim 1, wherein heating the preform comprises graphitization and crystallization of the carbonaceous resin.

15. The method of claim 1, wherein infiltrating a carbonaceous resin into the preform and heating the preform are repeated.

16. The method of claim 15, wherein infiltrating the carbonaceous resin into the preform and heating the preform are repeated only once.

17. The method of claim 1, wherein the C/C composite material comprises a continuous matrix of carbon.

18. The method of claim 1, wherein the C/C composite material has no more than 5 volume percent porosity.

19. The method of claim 1, wherein the C/C composite material has a maximum pore size of 5 microns.

20. The method of claim 1, wherein the C/C composite material has an average pore size in the range of less than or equal to 0.5 micron.
